(19) United States
(12) Patent Application Publication
(10) Pub. No.: US 2022/0050347 A1
(43) Pub. Date: Feb. 17, 2022

(54) METHOD FOR MANUFACTURING LIQUID CRYSTAL DISPLAY PANEL

(71) Applicant: Century Technology (Shenzhen) Corporation Limited, Shenzhen (CN)

(72) Inventors: ZHENG-XIA HE, Shenzhen (CN); NING FANG, Shenzhen (CN); YUAN XIONG, Shenzhen (CN); HUI WANG, Shenzhen (CN); WEN-LIN CHEN, Shenzhen (CN); CHIH-CHUNG LIU, New Taipei (TW)

(21) Appl. No.: 17/370,155

(22) Filed: Jul. 8, 2021

(30) Foreign Application Priority Data
Aug. 12, 2020 (CN) 202010809455.3

(51) Int. Cl. G02F 1/1362; G02F 1/1341; G02F 1/1339

(52) U.S. Cl. CPC G02F 1/136295; G02F 1/1339; G02F 1/1341

(57) ABSTRACT

A method for fast and convenient manufacture of liquid crystal display panels of different sizes without retooling provides an array substrate having a first display area of a first size. A closed-shaped sealant is coated onto the array substrate, the sealant defining a second display area of a second size, the second display area including an actual display area and an undesired display area adjacent to the actual display area and the sealant. Liquid crystals are applied in the second display area and sealing and coupling are carried out to obtain a liquid crystal cell, the liquid crystal cell being cut along an outer periphery of the sealant to obtain a working liquid crystal display panel of the desired size.

### FIELD

The subject matter herein generally relates to the technical field of displays, specifically a method for manufacturing a liquid crystal display panel.

### BACKGROUND

Liquid crystal display (LCD) panels with large display sizes such as 4:3 or 16:9 are common. If the liquid crystal display panels with small display sizes such as 4:1 or 16:3 are required, a mask needs to be redesigned and the manufacturing process re-developed for a new product, which consumes a lot of manpower, time, and cost.

Therefore, there is room for improvement in the art.

### BRIEF DESCRIPTION OF THE DRAWINGS

Implementations of the present disclosure will now be described, by way of embodiment, with reference to the attached figures.

FIG. 1 is a flow chart of a method for manufacturing a liquid crystal display panel according to an embodiment of the present disclosure.

FIG. 2 is a top view of the array substrate provided in Block S1 of the method of FIG. 1.

FIG. 3 is a schematic view of the array substrate after coating sealant in Block S2 of method of FIG. 1.

FIG. 4 is a schematic view showing a liquid crystal cell obtained in Block S4 of method of FIG. 1.

FIG. 5 is a schematic view of the liquid crystal display panel obtained in Block S5 of method of FIG. 1.

FIG. 6 is a cross-sectional view of taken along line VI-VI of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

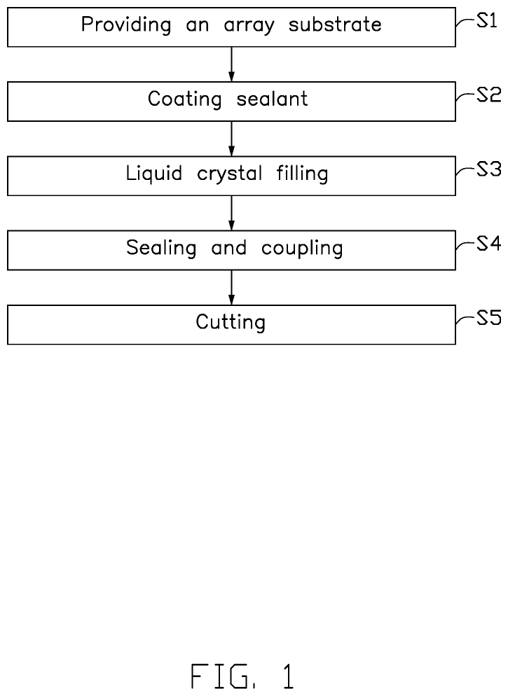

FIG. 1 is a flowchart of a method for manufacturing a liquid crystal display panel according to an embodiment of the present disclosure. The method can apply to the making of an array substrate and a color filter substrate of a liquid crystal display panel with a large display size (for example, 4:3 or 16:9, etc.) to a liquid crystal display panel with a small display size (for example, 4:1 or 16:3), without the need to redesign and develop the manufacturing process for a new product. The obtained liquid crystal display panel with the small display size may be a standard screen or a special-shaped screen.

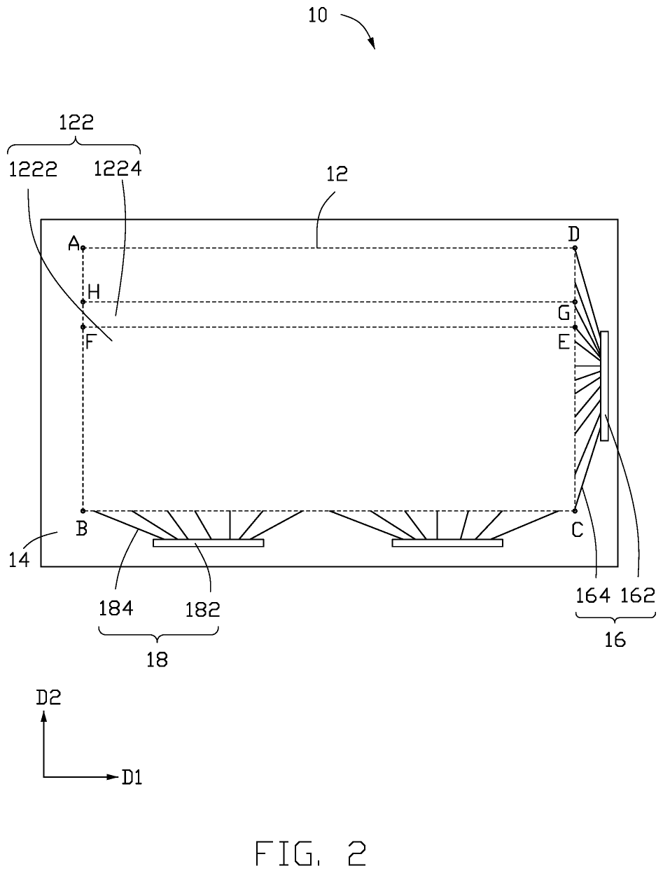

The example method is provided by way of example, as there are a variety of ways to carry out the method. The method described below can be carried out using the configurations illustrated in FIGS. 2 through 6, for example, and various elements of these figures are referenced in explaining the example method. Each block shown in FIG. 1 represents one or more processes, methods, or subroutines carried out in the example method. Furthermore, the illustrated order of blocks is by example only, and the order of the blocks can be changed. Additional blocks can be added, or fewer blocks can be utilized, without departing from this disclosure. The example method can begin at block S1.

In Block S1, an array substrate is provided.

As shown in FIG. 2, the array substrate 10 has a first display area 12 of a first size and a non-display area 14 at the periphery of the first display area 12.

In FIG. 2, the first display area 12 is defined as an area enclosed by the rectangle ABCD. The non-display area 14 is defined as an area outside the rectangle ABCD.

The array substrate 10 includes a plurality of scan lines (not shown), a plurality of data lines (not shown), a gate driving circuit 16, and a source driving circuit 18. The scan lines are in the first display area 12 and extend along a direction D1 which is parallel to the line between B and C, and the data lines are in the first display area 12 and extend along direction D2 which is parallel to the BA line, thus direction D1 is at a right angle to direction D2. The data lines and the scan lines intersect to define a plurality of sub-pixels. The gate driving circuit 16 and the source driving circuit 18 are both located in the non-display area 14 for controlling the first display area 12 to display images.

The gate driving circuit 16 and the source driving circuit 18 are at two adjacent peripheries, outside the BC line and outside the CD line of the first display area 12. The gate driving circuit 16 includes a gate driver 162 and a plurality of gate lines 164. The source driving circuit 18 includes a source driver 182 and a plurality of source lines 184. The scan lines are electrically connected to the gate driver 162 through the gate lines 164, and the data lines are electrically connected to the source driver 182 through the source lines 184. The gate driver 162 is used to drive the scan lines. The source driver 182 applies voltages to the sub-pixels through the data lines.

The first display area 12 includes a second display area 122 of a second size (less than the first size). The second display area 122 is an area defined by the rectangular HBCG The second display area 122 includes an actual display area 1222 (an area defined by the rectangular BCEF) and an undesired display area 1224 (an area defined by the rectangular FEGH). The gate driving circuit 16 and the source driving circuit 18 remain at the same peripheries of the actual display area 1222. The undesired display area 1224 is not used for screen display, and is an area set in consideration of subsequent coating accuracy of sealant and subsequent cutting accuracy. The edge HG of the undesired display area 1224 forms an inner boundary when applying sealant as a coating in a subsequent step.

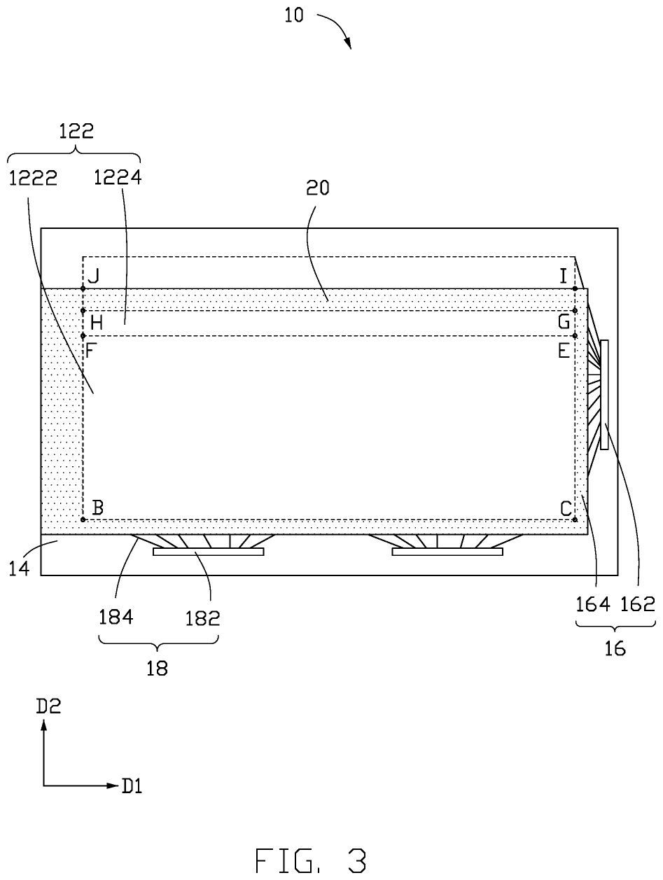

In one embodiment, a screen resolution of the first display area 12 of the first size is 1920*1080, and a screen resolution of the actual display area 1222 is 1920*720. That is, a length of AF is one third of a length of AB, and an area of the actual display area 1222 is one third of an area of the first display area 12. That is, the array substrate 10 and a color filter substrate 30 (labeled in FIG. 3) originally used for a display panel with a screen resolution of 1920*1080 are processed to form a liquid crystal display panel with a screen resolution of 1920*720. That is, a width of the actual display area 1222 is equal to a width of the first display area 12, and a length of the actual display area 1222 is one third of a length of the first display area 12. In other embodiments, the width of the actual display area and the width of the first display area, the length of the actual display area and the length of the first display area, may have other ratios.

In Block S2, the sealant is applied as a coating.

As shown in FIG. 3, the closed-shaped sealant 20 is coated on the array substrate 10. The sealant 20 defines the second display area 122 of the second size. The undesired display area 1224 is located between the actual display area 1222 and the sealant 20. The sealant 20 covers some of the gate lines 164 and some of the source lines 184 in the non-display area 14, but does not cover the gate driver 162 and the source driver 182.

In one embodiment, a width of the applied sealant 20 can be adjusted as needed.

In one embodiment, a width of the undesired display area 1224 (i.e., a length of the FH line) ranges from 0.3 mm to 5 mm. That is, the sealant 20 is applied to a distance of about 0.3 mm to 5 mm from the actual display area 1222, so as to avoid the size of the actual display area 1222 being affected by the coating accuracy of the sealant 20 and the subsequent cutting accuracy.

In one embodiment, Block S2 further includes curing the sealant 20 by ultraviolet radiation curing or thermal curing.

In Block S3, liquid crystal is applied.

In one embodiment, liquid crystal is injected into the second display area 122. That is, the sealant 20 defines the second display area 122 of the second size, and the liquid crystal is only injected into the area corresponding to the second display area 122 and not into the entire first display area 12. The method of directly cutting a display panel with a large display size and a large screen resolution into a liquid crystal display panel with a small display size and a small screen resolution saves liquid crystal materials.

In Block S4, sealing and coupling are performed.

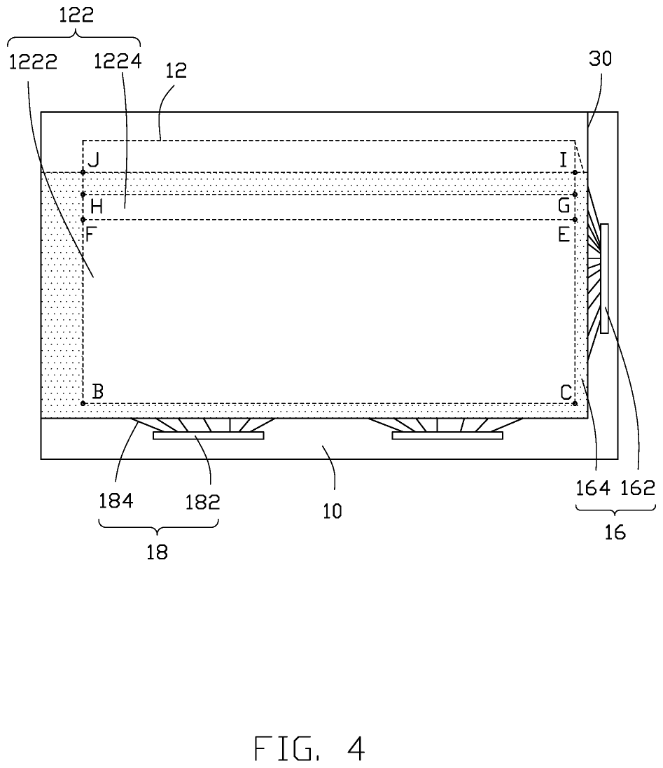

As shown in FIG. 4, the array substrate 10 and a color filter substrate 30 are hermetically combined to obtain a liquid crystal cell.

In one embodiment, the color filter substrate 30 is used for a liquid crystal display panel with a large display size and a large screen resolution. In FIG. 4, the color filter substrate 30 covers the entire first display area 12 and part of the non-display area 14, and the two sides are respectively aligned with the two sides of the array substrate 10, and the sealant 20 is located on the color filter substrate 30 and the array substrate 10 to maintain a cell thickness of the LCD panel. The gate driver 162 and the source driver 182 are not covered by the color filter substrate 30.

In Block S5, a cutting process is performed.

In one embodiment, the liquid crystal cell is cut along an outer periphery of the sealant 20 to obtain a liquid crystal display panel 100 with a small display size and a low screen resolution.

In FIG. 4, cutting is performed along the line (cutting line) where the outer periphery JI of the sealant 20 is located. The color filter substrate 30 and the array substrate 10 are both cut. All the data lines in the first display area 12 are cut at the cutting line, and some of the gate lines 164 in the non-display area are also cut at the cutting line.

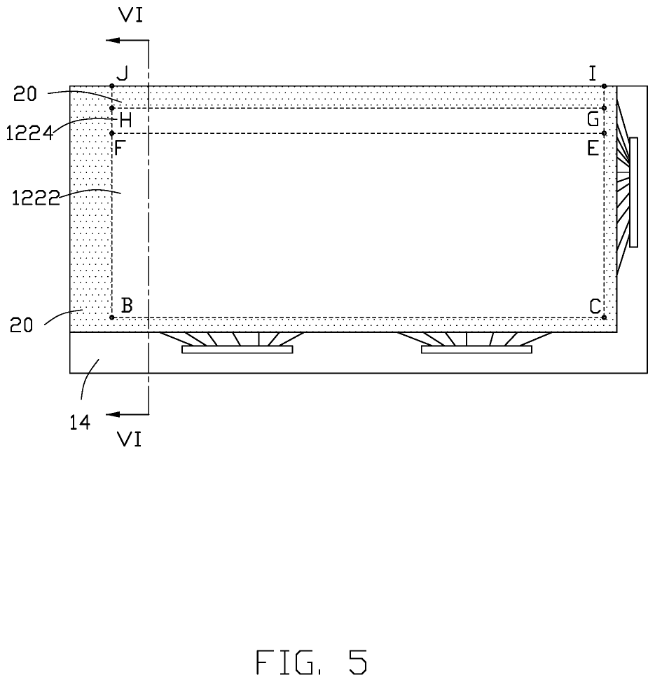

As shown in FIG. 5, the actual display area 1222 of the liquid crystal display panel 100 obtained after cutting is an area enclosed by lines BCFE. An area enclosed by lines FEGH is the undesired display area 1224.

In one embodiment, the color filter substrate 30 is provided with a black matrix for shielding, corresponding to the undesired display area 1224. In other embodiments, the undesired display area 1224 may be shielded by a metal frame. The undesired display area 1224 can also be blocked by giving a black picture.

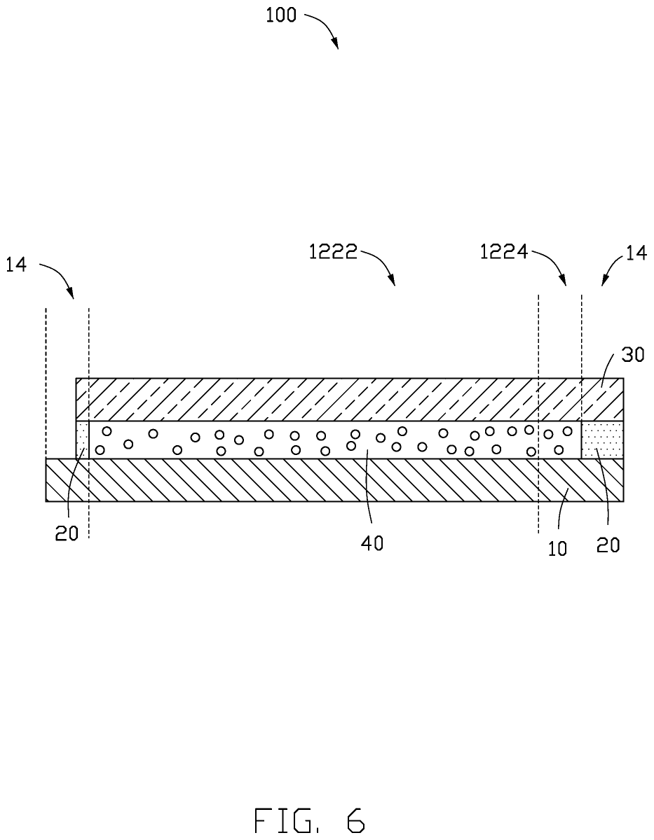

FIG. 6 a cross-sectional view taken along line VI-VI of FIG. 5. As shown in FIG. 6, the liquid crystal layer 40 is sandwiched between the array substrate 10 and the color filter substrate 30, and corresponds to the actual display area 1222 and the undesired display area 1224 containing liquid crystals. The sealant 20 is disposed in the non-display area 14 and is between the array substrate 10 and the color filter substrate 30 to maintain the cell thickness of the liquid crystal display panel 100. The array substrate 10 has a portion extending beyond the color filter substrate 30, such portion carries the gate driving circuit 16 or the source driving circuit 18.

In one embodiment, the actual display area 1222 may have a non-standard shape. That is, a shape of the second display area 122 defined by the sealant 20 is a non-standard shape. In the cutting step, the data lines and scan lines in the first display area 12 may be cut, but the gate driver 162 and the source driver 182 are never cut.

In one embodiment, the actual display area 1222 may be rectangular, and two adjacent peripheries of the actual display area 1222 are close to the gate driving circuit 16 and the source driving circuit 18. In the cutting step, cutting is performed along direction D2, so that the scan lines in the first display area 12 and the source lines 184 in the non-display area 14 are cut, while the gate driver 162 and the source driver 182 are not cut. Alternatively, in the cutting step, cutting is performed in both directions, D1 and D2, so that the scan lines and data lines in the first display area 12, and the source lines 184 and the gate lines 164 in the non-display area 14 are cut, but the gate driver 162 and the source driver 182 are not cut.

The embodiment of the present disclosure also provides a liquid crystal display panel obtained by the above method. It can be seen from FIGS. 4 and 5 that during the cutting step, some of the gate lines 164 are cut, and the number of gate lines 164 remaining on the array substrate 10 are not removed. The number of gate lines 164 remaining on the array substrate 10 can be covered with an insulating layer, etc., without affecting the display of the liquid crystal display panel 100. That is, the uncut gate lines 164 are used to control the display of the actual display area 1222, while the cut gate lines 164 remain on and are redundant on the array substrate 10, not affecting the display of the actual display area 1222. Similarly, if the source lines 184 are cut during the cutting step, the number of source lines 184 left after cutting on the array substrate 10 are not removed and are covered with an insulating layer, which will not affect the display of the liquid crystal display panel 100. That is, the uncut source lines 184 control the display of the actual display area 1222, while the redundant cut source lines 184 remaining on the array substrate 10 do not affect the display of the actual display area 1222.

In the method for manufacturing the liquid crystal display panel, by changing the sealant coating process and adding a panel cutting process, a liquid crystal display panel with a first display area of a first size (i.e., a large display size) can be changed to a liquid crystal display panel having an actual display area with a small display size instead of redesigning and doing development work necessary for a new product, which saves manpower, time, and cost.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A method for manufacturing a liquid crystal display panel, comprising:
providing an array substrate, the array substrate defining a first display area of a first size, the array substrate comprising a gate driving circuit and a source driving circuit at two adjacent peripheries of the first display area, the gate driving circuit and the source driving circuit being configured for controlling the first display area to display images;
coating a closed-shaped sealant on the array substrate, the sealant defining a second display area of a second size, the second display area comprising an actual display area and an undesired display area adjacent to the actual display area and the sealant, the second size being less than the first size;
filling liquid crystal into the second display area;
sealing and coupling the array substrate and a color filter substrate to obtain a liquid crystal cell; and
cutting the liquid crystal cell along an outer periphery of the sealant to obtain a liquid crystal display panel.

2. The method for manufacturing the liquid crystal display panel of claim 1, wherein the color filter substrate is provided with a black matrix corresponding to the undesired display area.

3. The method for manufacturing the liquid crystal display panel of claim 1, wherein the undesired display area is shielded by a metal frame.

4. The method for manufacturing the liquid crystal display panel of claim 1, wherein the undesired display area is blocked by giving a black picture.

5. The method for manufacturing the liquid crystal display panel of claim 1, wherein along a direction from the actual display area to the undesired display area, a width of the undesired display area ranges from 0.3 mm to 5 mm.

6. The method for manufacturing the liquid crystal display panel of claim 1, wherein in the cutting step, some scan lines in the first display area are cut.

7. The method for manufacturing the liquid crystal display panel of claim 1, wherein in the cutting step, some data lines in the first display area are cut.

8. The method for manufacturing the liquid crystal display panel of claim 1, wherein the gate driving circuit comprises a gate driver and a plurality of gate lines, the source driving circuit comprises a source driver and a plurality of source lines; in the cutting step, the gate driver and the source driver are not cut.

9. The method for manufacturing the liquid crystal display panel of claim 8, wherein in the cutting step, some of the gate lines are cut.

10. The method for manufacturing the liquid crystal display panel of claim 9, wherein the cut gate lines remain on the liquid crystal display panel and are redundant on the liquid crystal display panel.

11. The method for manufacturing the liquid crystal display panel of claim 8, wherein in the cutting step, some of the source lines are cut.

12. The method for manufacturing the liquid crystal display panel of claim 11, wherein the cut source lines remain on the liquid crystal display panel and are redundant on the liquid crystal display panel.

13. The method for manufacturing the liquid crystal display panel of claim 1, further comprising curing the sealant.

14. The method for manufacturing the liquid crystal display panel of claim 13, wherein curing the sealant is carried out by UV curing or thermal curing.

15. The method for manufacturing the liquid crystal display panel of claim 1, wherein a length of the actual display area is one third of a length of the first display area, and a width of the actual display area is equal to a width of the first display area.

16. The method for manufacturing the liquid crystal display panel of claim 15, wherein a screen resolution of the first display area is 1920*1080, and a screen resolution of the actual display area is 1920*720.
